(19) United States
(12) Patent Application Publication
(10) Pub. No.: US 2013/0257382 A1
(43) Pub. Date: Oct. 3, 2013

(54) Managing Cycle and Runtime in Batteries for Portable Electronic Devices

(71) Applicants: J. Douglas Field, Los Gatos, CA (US); William C. Athas, San Jose, CA (US)

(72) Inventors: J. Douglas Field, Los Gatos, CA (US); William C. Athas, San Jose, CA (US)

(73) Assignee: APPLE INC., Cupertino, CA (US)

(21) Appl. No.: 13/467,687

(22) Filed: May 9, 2012

Related U.S. Application Data
(60) Provisional application No. 61/618,977, filed on Apr. 2, 2012.

(51) Int. Cl. H02J 7/00

(52) U.S. Cl. 320/134; 320/164; 320/136

(57) ABSTRACT

The disclosed embodiments provide a system that manages use of a battery in a portable electronic device. The system includes a monitoring mechanism that monitors one or more battery-usage parameters of the battery during use of the battery with the portable electronic device. The battery-usage parameters may include a battery age, a resting time, a swell rate, a temperature, a cell balance, a voltage, a current, usage data about how the battery has been cycled, and/or user input. The system also includes a management apparatus that adjusts a charge-termination voltage or a discharge-termination voltage of the battery based on the battery-usage parameters to manage a cycle life of the battery, the swell rate, and/or a runtime of the battery.

### RELATED APPLICATION

This application claims priority to U.S. Provisional Application No. 61/618,977, Attorney Docket Number APL-P11290USP1, entitled “Managing Cycle Life and Runtime in a Batteries for Portable Electronic Devices,” by inventors William C. Athas and J. Douglas Field, filed 2 Apr. 2012, the contents of which are incorporated herein by reference.

### BACKGROUND

1. Field

The present embodiments relate to batteries for portable electronic devices. More specifically, the present embodiments relate to techniques for managing cycle life and runtime in batteries for portable electronic devices.

2. Related Art

Portable electronic devices, such as laptop computers, portable media players, and/or mobile phones, commonly operate using rechargeable batteries that utilize lithium-ion chemistry. Such rechargeable batteries are excellent examples of extremely reversible systems in that the batteries may be cycled from a low state-of-charge to a high state-of-charge thousands of times. The graph of FIG. 1 shows the electrochemical potential of an idealized battery as the battery's state-of-charge transitions between two extremes. The curve in FIG. 1 defines a reversible path in the battery: left-to-right represents a discharge process while right-to-left corresponds to a charge process. The points at which charging and discharging halt are not the points at which the battery is completely full or empty. Instead, the points may be determined by a balanced set of needs associated with use of the battery.

First, the runtime of the battery may correspond to the amount of time in which the battery may be operated from a fully charged state to a fully discharged state. In addition, the battery's energy capacity may correspond to the amount of charge the battery may accept between two predefined points along the state-of-charge curve. Thus, extending the limit points along the state-of-charge curve may result in longer battery runtime. For example, the runtime of the battery may be increased by using points 102-104 as the endpoints for charging and discharging the battery instead of points 106-108.

On the other hand, the cycle life of the battery may be defined as the number of times the battery can be cycled while retaining a substantial percentage (e.g., 80%) of the battery's initial capacity. During charging and discharging of the battery, the first-order electrochemical reactions of the battery are fully reversible, but the second-order reactions may lead to irreversibility. For example, continued charging and discharging of the battery and/or resting of the battery at a significantly low or high state-of-charge may oxidize the electrolyte and/or degrade the cathode and anode material in the battery, resulting in reduced capacity and/or swelling in the battery. As a result, shortening the distance between points along the state-of-charge curve may increase the battery's cycle life. For example, the battery may have a longer cycle life if points 106-108 are used as endpoints for charging and discharging of the battery instead of points 102-104.

Consequently, the operation of the battery may be associated with a tradeoff between runtime and cycle life. By extending the operating range of the battery over the state-of-charge curve (e.g., using points 102-104), the battery's runtime may be increased at the cost of a shortened cycle life. Conversely, constraining the operating range (e.g., using points 106-108) may extend the battery's cycle life while reducing the battery's runtime.

Hence, battery operation may be improved through mechanisms for managing the tradeoff between battery runtime and cycle life.

### SUMMARY

The disclosed embodiments provide a system that manages use of a battery in a portable electronic device. The system includes a monitoring mechanism that monitors one or more battery-usage parameters of the battery during use of the battery with the portable electronic device. The battery-usage parameters may include a cycle number, a battery age, a resting time, a swell rate, a temperature, a cell balance, a voltage, a current, usage data about how the battery has been cycled, and/or user input. The system also includes a management apparatus that adjusts a charge-termination voltage and/or a discharge-termination voltage of the battery based on the battery-usage parameters to manage a cycle life of the battery, the swell rate, and/or a runtime of the battery.

In some embodiments, the system also includes a set of control registers configured to store the charge-termination voltage, the discharge-termination voltage, the cycle number, and/or a cycle limit of the battery.

In some embodiments, the system also includes a non-resettable timer that tracks the battery age and a watchdog timer that tracks the resting time.

In some embodiments, the system also includes a lookup table containing a set of elements. Each of the elements includes a threshold for a battery-usage parameter from the battery-usage parameters, a first value associated with the charge-termination voltage, and a second value associated with the discharge-termination voltage. If the battery-usage parameter exceeds the threshold, the system sets the charge-termination voltage to the first value and the discharge-termination voltage to the second value. For example, if the cycle number exceeds a cycle number threshold, the system may reduce the charge-termination voltage and/or increase the discharge-termination voltage to improve the cycle life and/or swell rate of the battery. Alternatively, the system may temporarily increase the charge-termination voltage and/or decrease the discharge-termination voltage based on the user input to improve the runtime of the battery.

### BRIEF DESCRIPTION OF THE FIGURES

FIG. 1 shows a state-of-charge curve for a battery in accordance with an embodiment.

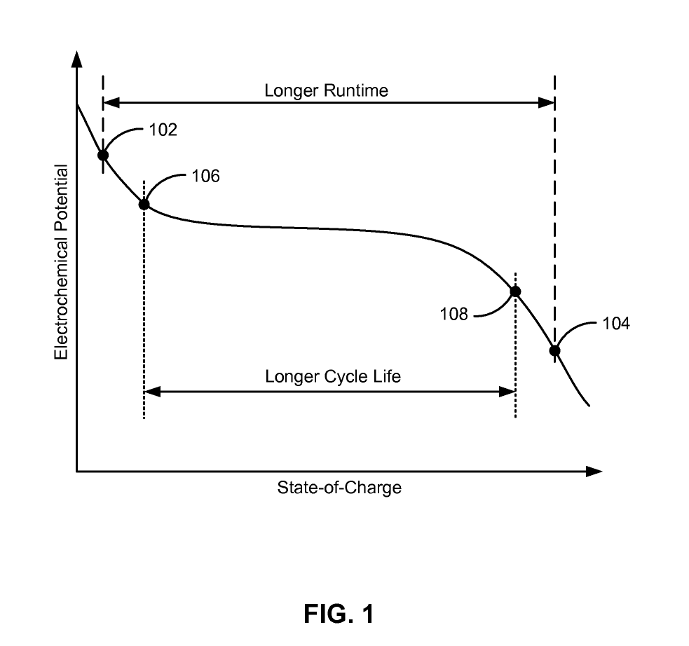

FIG. 2 shows a schematic of a system in accordance with an embodiment.

FIG. 3 shows a system for managing use of a battery in a portable electronic device in accordance with an embodiment.

FIG. 4 shows an exemplary technique for managing the charging and discharging of a battery in accordance with an embodiment.

FIG. 5 shows a flowchart illustrating the process of managing use of a battery in a portable electronic device in accordance with an embodiment.

FIG. 6 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for monitoring a battery in a portable electronic device. The battery may include one or more cells in a parallel and/or series configuration and supply power to a mobile phone, laptop computer, portable media player, tablet computer, and/or other battery-powered electronic device. For example, the battery may correspond to a lithium-polymer battery. In addition, the battery may be reused up to a number of charge cycles before losing enough capacity to reach an end-of-life. The battery may also swell as capacity diminishes over time.

More specifically, the disclosed embodiments provide a method and system for managing the tradeoff between cycle life and runtime in the battery. During use of the battery with the portable electronic device, one or more battery-usage parameters of the battery may be monitored. The battery-usage parameters may include a cycle number, a battery age, a resting time, a swell rate, a temperature, a cell balance, a voltage, a current, a rate of change in battery capacity, an amount of time of battery banks can maintain a balanced state and/or user input. Note that the “rate of change in battery capacity” indicates how much the battery capacity changes across a number of charge-discharge cycles and/or over time. Also, the “amount of time battery banks can maintain a balanced state” indicates how long battery banks can maintain a balanced state after voltages on the banks are brought into balance.

Next, the battery-usage parameters may be used to adjust a charge-termination voltage and/or discharge-termination voltage of the battery to manage the battery's cycle life, swell rate, and/or runtime. A set of registers may be used to adjust the charge-termination voltage and discharge-termination voltage and/or record the cycle number, battery age, resting time, and/or a cycle limit of the battery. If one or more of the battery-usage parameters exceeds a pre-specified threshold, the charge-termination voltage may be decreased and/or the discharge-termination voltage may be increased to improve the battery's cycle life and/or swell rate. For example, the battery's capacity may be reduced by shortening the distance between the endpoints along the battery's state-of-charge curve each time the battery exceeds a cycle number threshold and rests at a high state-of-charge for an extended period of time to mitigate degradation and/or swelling in the battery and extend the battery's useful life.

Conversely, the charge-termination voltage may be increased and/or the discharge-termination voltage may be decreased to improve the battery's runtime in response to user input from a user of the portable electronic device. For example, the battery's capacity may be increased a limited number of times in response to user requests for extended runtime by extending the distance between the endpoints along the battery's state-of-charge curve. Also, the charge-termination voltage may be increased and/or the discharge-termination voltage may be decreased in response to operational or usage data logged by the system as to how the battery has been operated. For example, the system may adjust the termination voltages depending upon usage data specifying whether the battery has been mostly cycled between 50% and 100% versus 10% and 80%. In another example, if the battery banks fail to maintain a balanced state for a period of time after the voltages on the battery banks are brought into balance, the charge-termination voltage and the discharge-termination voltage can be adjusted. Such adjustments ensure that the battery can continue to operate event through voltages across the battery banks are tending to become unbalanced. (For more details on a system that maintains a balanced voltage between battery banks, please refer to pending U.S. patent application Ser. No. 13/360,980 (filed 30 Jan. 2012), entitled “Balancing Voltages between Battery Banks,” by inventors William C. Athas and Tom Greening.) Such adjustments to the charge-termination and/or discharge-termination voltages may thus enable dynamic management of the battery's cycle life and runtime throughout the lifetime of the battery.

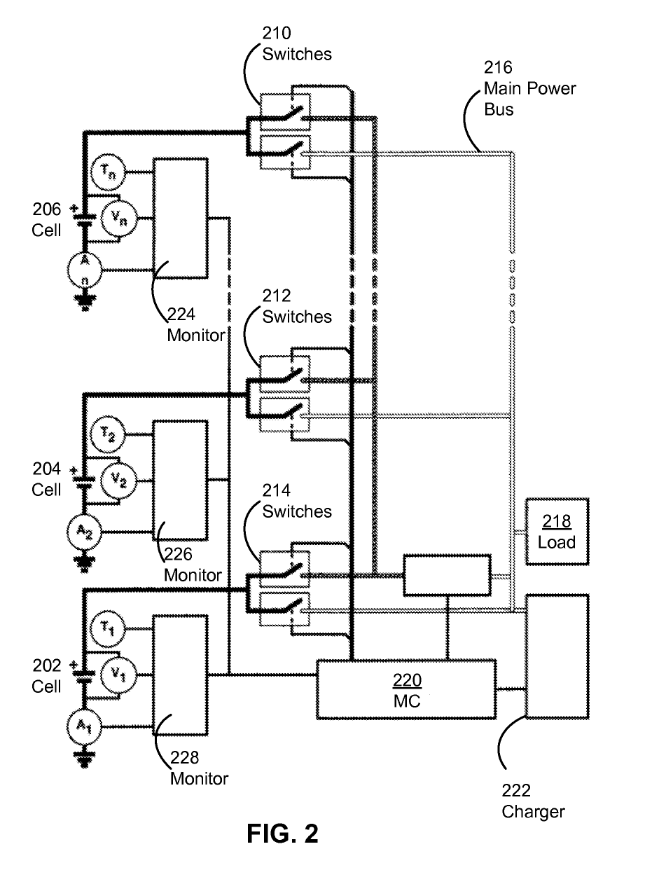

FIG. 2 shows a schematic of a system in accordance with an embodiment. The system may provide a power source to a portable electronic device, such as a mobile phone, personal digital assistant (PDA), laptop computer, tablet computer, portable media player, and/or peripheral device. In other words, the system may correspond to a battery that supplies power to a load 218 from one or more components (e.g., processors, peripheral devices, backlights, etc.) within the portable electronic device. For example, the battery may correspond to a lithium-polymer battery that includes one or more cells 202-206, each of which includes a jelly roll of layers wound together (e.g., a cathode with an active coating, a separator, and an anode with an active coating), and a flexible pouch enclosing the jelly roll. As shown in FIG. 2, the system also includes a set of switches 210-214, a main power bus 216, a microcontroller (MC) 220, a charger 222, and a set of monitors 224-228.

In one or more embodiments, cells 202-206 are connected in a series and/or parallel configuration with one another using main power bus 216. Each cell 202-206 may include a sense resistor (not shown) that measures the cell's current. Furthermore, the voltage and temperature of each cell 202-206 may be measured with a thermistor (not shown), which may further allow a battery “gas gauge” mechanism to determine the cell's state-of-charge, impedance, capacity, charging voltage, and/or remaining charge. Measurements of voltage, current, temperature, and/or other parameters associated with each cell 202-206 may be collected by a corresponding monitor 224-228. Alternatively, one monitoring apparatus may be used to collect sensor data from multiple cells 202-206 in the battery.

Data collected by monitors 224-228 may then be used by MC 220 to assess the state-of-charge, capacity, and/or health of cells 202-206. Monitors 224-228 and MC 220 may be implemented by one or more components (e.g., processors, circuits, software modules, etc.) of the portable electronic device.

In particular, MC 220 may use the data to manage use of the battery in the portable electronic device. For example, MC 220 may correspond to a management apparatus that uses the state-of-charge of each cell 202-206 to adjust the charging and/or discharging of the cell by connecting or disconnecting the cell to main power bus 216 and charger 222 using a set of switches 210-214. Fully discharged cells may be disconnected from main power bus 216 during discharging of the battery to enable cells with additional charge to continue to supply power to load 218. Along the same lines, fully charged cells may be disconnected from main power bus 216 during charging of the battery to allow other cells to continue charging.

Those skilled in the art will appreciate that operation of the battery may be associated with a tradeoff between the battery's cycle life and the battery's runtime. In particular, reducing the voltage range over which the battery is charged and discharged may slow cathode oxidation, swelling, and/or other degradation in the battery, thus extending the battery's cycle life at the cost of reduced runtime. On the other hand, extending the voltage range along the battery's state-of-charge curve may increase the runtime of the battery on a single charge at the expense of reduced long-term capacity, increased swelling, and a shortened cycle life.

In addition, a user of the portable electronic device may not be aware of the loss of capacity and/or swelling associated with aging of the battery and may continue using the battery with the portable electronic device beyond the battery's end-of-life. For example, a mobile phone battery with an initial runtime of 10 hours may begin swelling beyond an 8% swell budget in the mobile phone after the runtime drops below 8 hours. However, a user of the mobile phone may not notice the decrease in runtime and may continue using the mobile phone without replacing the battery, thus subjecting the mobile phone to damage from the swelling.

A number of other factors may also affect the operation and/or cycle life of the battery. First, the operation of the battery at lower temperatures (e.g., below room temperature) may reduce the battery's runtime. For example, the battery may deliver 100% of the capacity stored between the endpoints of the battery's state-of-charge curve at 25° Celsius but only 50% of the same capacity at −18° Celsius. Conversely, operation of the battery at higher temperatures (e.g., above room temperature) may reduce the battery's cycle life and/or increase swelling in the battery. For example, a lithium-polymer battery with 1050 charge-discharge cycles may reach 80% of initial capacity and increase in thickness by 8% if operated at 25° Celsius. However, operation of the same battery at 45° Celsius may decrease the capacity to 70% of initial capacity and increase the swelling to 10% after 1050 charge-discharge cycles.

Second, swelling and/or degradation in the battery may be affected by periods during which the battery rests at certain states-of-charge. For example, extended resting of the battery at a very high (e.g., 100%) or very low (e.g., 0%) state-of-charge may accelerate cathode oxidation and/or swelling in the battery. As a result, continued charging of the battery to maintain a fully charged state may prematurely age the battery, even if the battery is not being used to supply power to the portable electronic device.

In one or more embodiments, the system of FIG. 2 includes functionality to dynamically manage battery runtime and cycle life in response to changes in the battery's environment and/or operating conditions. During use of the battery with the portable electronic device, monitors 224-228 and/or MC 220 may monitor one or more battery-usage parameters of the battery. The battery-usage parameters may include a cycle number, a battery age, a resting time, a swell rate, a temperature, a cell balance, a voltage, a current, and/or user input.

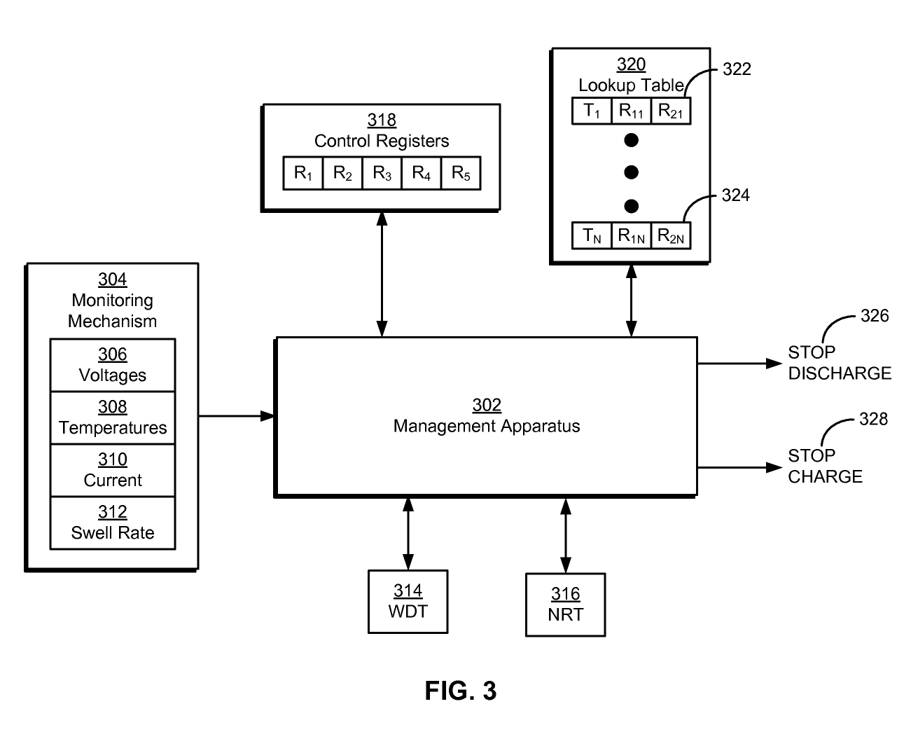

Next, MC 220 may adjust a charge-termination voltage and/or discharge-termination voltage of the battery based on the battery-usage parameters to manage the battery's cycle life, runtime, and/or swell rate. For example, MC 220 may decrease the charge-termination voltage and/or increase the discharge-termination voltage every few hundred charge-discharge cycles and/or after each year that passes during operation of the battery to mitigate capacity loss and/or swelling in the battery. Alternatively, MC 220 may increase the charge-termination voltage and/or decrease the discharge-termination voltage in response to user input to increase the runtime of the battery on a single charge. Adjustments to the charge-termination and/or discharge-termination voltages based on battery-usage parameters are discussed in further detail below with respect to FIG. 3.

FIG. 3 shows a system for managing use of a battery in a portable electronic device in accordance with an embodiment. The system of FIG. 3 may include a management apparatus 302, a monitoring mechanism 304, a watchdog timer (WDT) 314 register, a non-resettable timer (NRT) 316 register, a set of control registers 318, and a lookup table 320.

Management apparatus 302 may correspond to an MC, such as MC 220 of FIG. 2. In addition, management apparatus 302 may be implemented using system software, firmware, and/or a set of state machines. To manage use of the battery, management apparatus 302 may obtain a set of voltages 306, a set of temperatures 308, a current 310, and/or a swell rate 312 for the battery from monitoring mechanism 304.

Monitoring mechanism 304 may use a number of sensors to monitor voltages 306, temperatures 308, current 310, and/or swell rate 312. For example, monitoring mechanism 304 may use one or more sense resistors to measure current 310, one or more thermistors to measure voltages 306 and temperatures 308, and one or more swell sensors (e.g., strain gauges, force-sensing resistors, etc.) to measure swell rate 312. As mentioned above, management apparatus 302 may use measurements from monitoring mechanism 304 to assess the state-of-charge, capacity, cell balance, and/or health of the battery, as well as manage the charging and/or discharging of the battery.

More specifically, management apparatus 302 may use voltages 306, temperatures 308, current 310, and/or swell rate 312 to update one or more control registers 318. As shown in FIG. 3, control registers 318 include five registers named R₁, R₂, R₃, R₄, and R₅. R₁ may define the charge-termination voltage of the battery, and R₂ may define the discharge-termination voltage of the battery. The value stored in R₁ may represent the voltage at which charging of the battery stops, while the value stored in R₂ may represent the voltage at which discharging of the battery ceases. Management apparatus 302 may use the values in R₁ and R₂, along with voltages 306 from monitoring mechanism 304, to issue a stop discharge signal 326 when the discharge voltage of the battery reaches the value stored in R₂ to prevent discharging of the battery past the discharge-termination voltage. Similarly, management apparatus 302 may issue a stop charge signal 328 when the charge voltage of the battery reaches the value in R₁ to prevent charging of the battery past the charge-termination voltage.

Management apparatus 302 may use the R₃ register to track the cycle number of the battery. R₃ may be cleared upon initial use of the battery. The value in R₃ may then be incremented each time the battery makes a roundtrip from a substantially high state-of-charge stored in the R₄ register to a substantially low state-of-charge stored in the R₅ register. As a result, R₄ and R₅ may define the cycle limits of the battery, while R₁ and R₂ may define the runtime limits of the battery. For example, the value in R₄ may be 20% less than the value in R₁, while the value in R₅ may be 20% more than the value in R₂.

Management apparatus 302 may also use NRT 316 to monitor a battery age for the battery. As with R₃, NRT 316 may be cleared prior to use of the battery and begin incrementing once the battery is used with the portable electronic device. Moreover, NRT 316 may measure the total amount of time the battery has been resting in a fully charged state since the battery's initial use, or NRT 316 may measure the total amount of time since the battery was first used with the portable electronic device. In other words, NRT 316 may represent the absolute age of the battery, independently of the number of times the battery has been cycled.

On the other hand, management apparatus 302 may use WDT 314 to monitor a resting time of the battery. WDT 314 may be started once management apparatus 302 detects resting of the battery at a full state-of-charge and reset once the battery is no longer resting at the full state-of-charge. WDT 314 may thus track the amount of time the battery remains connected to a charger while at a full state-of-charge.

In one or more embodiments, data obtained from monitoring mechanism 304 and/or registers 314-318 is used by management apparatus 302 to manage the battery's cycle life, swell rate, and/or runtime. As described above, the data may correspond to a set of battery-usage parameters that includes a cycle number (e.g., from register R₃), a battery age (e.g., from NRT 316), and a resting time (e.g., from WDT 314). The battery-usage parameters may also include swell rate 312, temperatures 308, a cell balance (e.g., based on voltages 306), voltages 306, current 310, and/or user input (e.g., from a user of the portable electronic device).

More specifically, management apparatus 302 may use the battery-usage parameters and lookup table 320 to adjust the charge-termination voltage in R₁ and/or the discharge-termination voltage in R₂. Lookup table 320 may include a set of elements 322-324, with each element containing a threshold (e.g., T₁, T_{N}) for a battery-usage parameter, a first value associated with the charge-termination voltage (e.g., R₁₁, R_{1N}), and a second value associated with the discharge-termination voltage (e.g., R₂₁, R_{2N}). If the battery-usage parameter exceeds the corresponding threshold in lookup table 320, management apparatus 302 may set the charge-termination voltage in R₁ to the first value and the discharge-termination voltage in R₂ to the second value. For example, if swell rate 312 exceeds the value stored in T₁, management apparatus 302 may set the value of R₁ to the value stored in R₁₁ and the value of R₂ to R₂₁.

To improve the battery's cycle life and swell rate 312, management apparatus 302 may decrease the charge-termination voltage and/or increase the discharge-termination voltage. For example, management apparatus 302 may slow aging in the battery by lowering the available capacity for charging and discharging the battery every few hundred charge-discharge cycles and/or each time WDT 314 finishes counting down (e.g., reaches zero). Because the battery operates within a narrower range of voltages along the battery's state-of-charge curve, degradation and/or swelling associated with extreme states-of-charge in the battery may be mitigated.

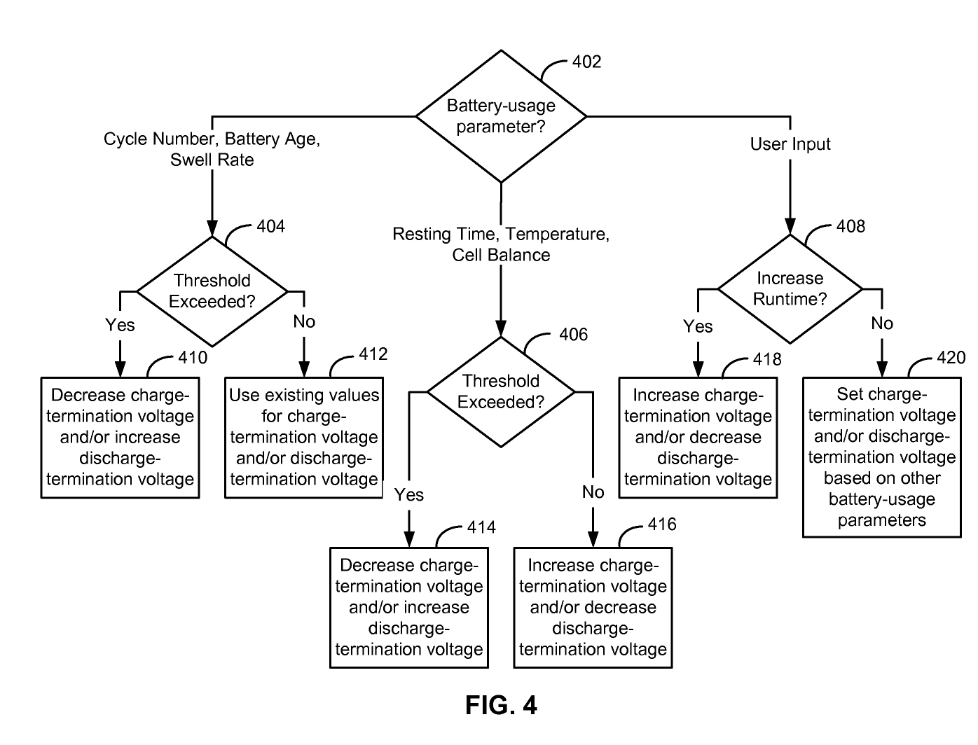

Alternatively, to improve the battery's runtime, management apparatus 302 may increase the charge-termination voltage and/or decrease the discharge-termination voltage. Because the battery may charge and discharge over a wider range of voltages, the battery may provide power to the portable electronic device for a longer period of time. Such improved runtime may be provided in response to user input and/or the falling of a battery-usage parameter below a threshold for the battery-usage parameter in lookup table 320. For example, increased runtime may be provided in response to a falling temperature, a user request to reset WDT 314, a user request to prioritize the battery's runtime over cycle life, the resetting of WDT 314 by a second watchdog timer, and/or the resetting of WDT 314 based on usage patterns associated with the battery. Adjustments to the charge-termination and/or discharge-termination voltages based on battery-usage parameters are discussed in further detail below with respect to FIG. 4.

By continuously monitoring battery-usage parameters and adjusting the voltage range used to charge and discharge the battery, the system of FIG. 3 may dynamically balance the tradeoff between cycle life and runtime in the battery. The system may additionally use the battery-usage parameters to mitigate situations that temporarily interfere with optimal operation of the battery. For example, the management apparatus 302 may temporarily restrict the voltage range of the battery in response to higher temperatures, cell imbalances, and/or longer resting times to offset accelerated degradation and/or swelling in the battery. On the other hand, management apparatus 302 may temporarily extend the voltage range of the battery in response to lower temperatures and/or user input to compensate for reductions in the battery's runtime. Consequently, the system of FIG. 3 may facilitate both short-term and long-term use of the battery with the portable electronic device.

FIG. 4 shows an exemplary technique for managing the charging and discharging of a battery in accordance with an embodiment. As discussed above, the charging and/or discharging of the battery may be modified based on the type of battery-usage parameter 402 associated with the battery.

First, the battery-usage parameter may be a cycle number, battery age, swell rate, and/or another monotonically increasing value that is indicative of degradation in the battery. Such battery-usage parameters may thus only exceed thresholds 404 over time. If a threshold is exceeded by one of the battery-usage parameters, the charge-termination voltage of the battery is decreased and/or the discharge-termination voltage of the battery is increased 410. For example, the range of voltages spanned by the charge-termination voltage and discharge-termination voltage may be reduced whenever the cycle number exceeds a cycle number threshold (e.g., 1050, 1300, 1450, etc.), the swell rate exceeds a swell rate threshold (e.g., 5%, 8%, etc), and/or the battery age exceeds a battery age threshold (e.g., one year, two years, etc.). If the threshold is not exceeded, existing values for the charge-termination voltage and/or discharge-termination voltage may be used 412.

Conversely, the battery-usage parameter may be a resting time, temperature, cell balance, and/or other reversible value. Because the battery-usage parameter may temporarily exceed and then fall below a corresponding threshold 406, the charge-termination voltage and discharge-termination voltage may move back and forth between pairs of values based on the battery-usage parameter. If the battery-usage parameter exceeds a threshold, the charge-termination voltage may be decreased and/or the discharge-termination voltage may be increased 414. If the battery-usage parameter is at or below the threshold, the charge-termination voltage may be increased and/or the discharge-termination voltage may be decreased 416. For example, the charge-termination and discharge-termination voltages may be moved closer to one another if one or more temperatures exceeds a temperature threshold (e.g., 45° Celsius), the cell balance exceeds a cell balance threshold (e.g., 1.0V), and/or the resting time of the battery exceeds a resting time threshold (e.g., one hour). Once the temperature(s), cell balance, and/or resting time drop below the corresponding thresholds, the charge-termination and discharge-termination voltages may revert to spanning a wider range of voltages.

Finally, the battery-usage parameter may be user input associated with operation of the battery in the portable electronic device. In addition, the user input may request an increase in the runtime 408 of the battery. For example, increased runtime may be requested in anticipation of extended use of the portable electronic device without access to a charger for the battery. Furthermore, the user input may be used to reset a watchdog timer (e.g., watchdog timer 314 of FIG. 3) that tracks the battery's resting time and/or prioritize the battery's runtime over the battery's cycle life. If increased runtime is requested, the charge-termination voltage is increased and/or the discharge-termination voltage is decreased 418. If the increased runtime is not requested, not available (e.g., after a certain number of requests for increased runtime have been used up), and/or has been consumed in a discharge cycle, the charge-termination voltage and/or discharge-termination voltage may be set based on the other battery-usage parameters 420, as discussed above.

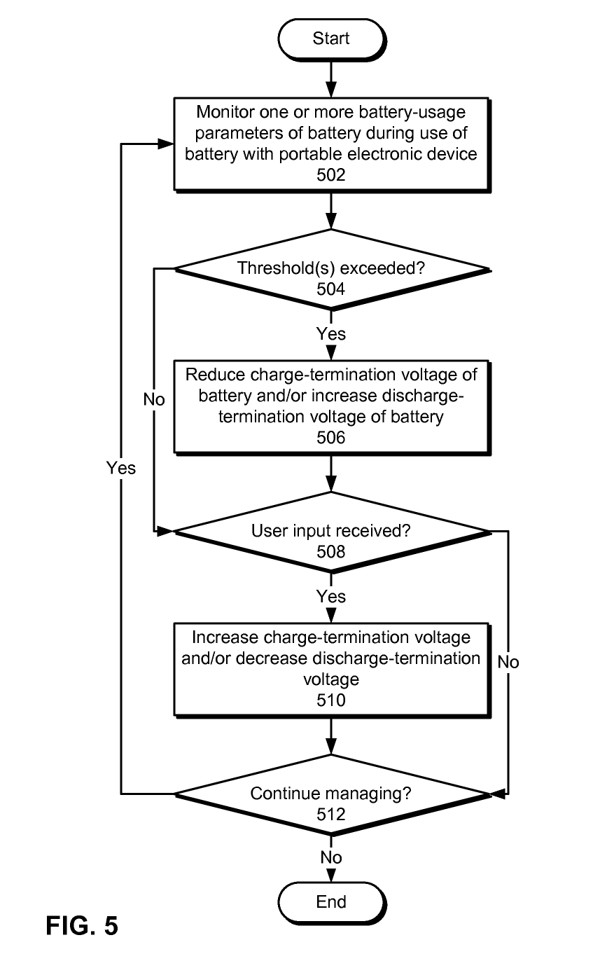

FIG. 5 shows a flowchart illustrating the process of managing use of a battery in a portable electronic device in accordance with an embodiment. In one or more embodiments, one or more of the steps may be omitted, repeated, and/or performed in a different order. Accordingly, the specific arrangement of steps shown in FIG. 5 should not be construed as limiting the scope of the embodiments.

Initially, one or more battery-usage parameters of the battery are monitored during use of the battery with the portable electronic device (operation 502). The battery-usage parameters may include a cycle number, a battery age, a resting time, a swell rate, a temperature, a cell balance, a voltage, a current, and/or user input.

Next, a charge-termination voltage and/or a discharge-termination voltage of the battery may be adjusted based on the battery-usage parameters to manage a cycle life of the battery, the swell rate, and/or a runtime of the battery. First, a battery-usage parameter may exceed a threshold (operation 504). If the threshold is exceeded, the charge-termination voltage is reduced and/or the discharge-termination voltage is increased (operation 506) to improve the cycle life and/or swell rate of the battery. If the threshold is not exceeded, the charge-termination voltage is not reduced and the discharge termination voltage is not increased.

User input may also be received (operation 508). The user input may request an increase in the runtime of the battery. If the user input is received, the charge-termination voltage is increased and/or the discharge-termination voltage is decreased (operation 510) to improve the runtime of the battery. If no user input is received and/or increased runtime is not available in the battery, the charge-termination voltage is not increased and the discharge-termination voltage is not decreased.

Management of the battery in the portable electronic device may continue (operation 512) during use of the battery with the portable electronic device. If the battery is to be managed, the battery-usage parameter(s) may be monitored (operation 502) and used to adjust the charge-termination and/or discharge-termination voltages of the battery (operations 504-510). The battery may thus continue to be monitored and managed until the battery is replaced and/or use of the battery is disabled.

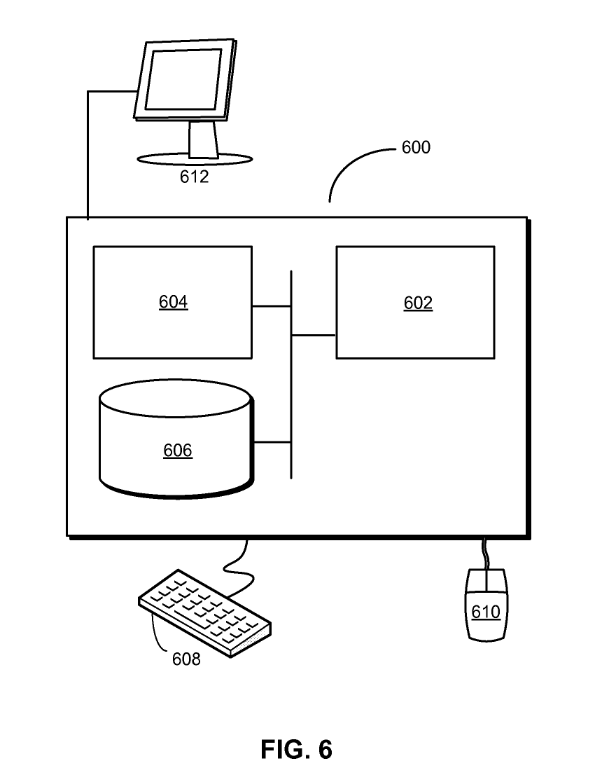

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for managing use of a battery in a portable electronic device. The system may include a monitoring mechanism that monitors one or more battery-usage parameters of the battery during use of the battery with the portable electronic device. The battery-usage parameters may include a cycle number, a battery age, a resting time, a swell rate, a temperature, a cell balance, a voltage, a current, and/or user input. The system may also include a management apparatus that adjusts a charge-termination voltage and/or a discharge-termination voltage of the battery based on the battery-usage parameters to manage a cycle life of the battery, the swell rate, and/or a runtime of the battery.

The system may store the charge-termination voltage, discharge-termination voltage, cycle number, and/or a cycle limit of the battery using a set of control registers. The system may additionally use a non-resettable timer to track the battery age and a watchdog timer to track the resting time. Finally, the system may include a lookup table containing a set of elements, with each of the elements storing a threshold for a battery-usage parameter from the battery-usage parameters, a first value associated with the charge-termination voltage, and a second value associated with the discharge-termination voltage. If the battery-usage parameter exceeds the threshold, the system may set the charge-termination voltage to the first value and the discharge-termination voltage to the second value. Alternatively, the system may temporarily increase the charge-termination voltage and/or decrease the discharge-termination voltage based on the user input to improve the runtime of the battery.

In addition, one or more components of computer system 600 may be remotely located and connected to the other components over a network. Portions of the present embodiments (e.g., monitoring mechanism, management apparatus, control registers, non-resettable timer, watchdog timer, lookup table, etc.) may also be located on different nodes of a distributed system that implements the embodiments. For example, the present embodiments may be implemented using a cloud computing system that monitors and manages batteries in remote portable electronic devices.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

1. A computer-implemented method for managing use of a battery in a portable electronic device, comprising:
monitoring one or more battery-usage parameters of the battery during use of the battery with the portable electronic device, wherein the one or more battery-usage parameters comprise at least one of a swell rate, a temperature, a cell balance, a voltage, a current, a rate of change in battery capacity, an amount of time of banks in the battery can maintain a balanced state and user input; and
adjusting a charge-termination voltage of the battery based on the battery-usage parameters to manage at least one of a cycle life of the battery, the swell rate, and a runtime of the battery.

2. The computer-implemented method of claim 1, wherein the one or more battery-usage parameters additionally comprise at least one of the following:
a battery age;
a resting time; and
usage data about how the battery has been cycled.

3. The computer-implemented method of claim 1, further comprising:
adjusting a discharge-termination voltage of the battery based on the battery-usage parameters.

4. The computer-implemented method of claim 2, wherein the charge-termination voltage and the discharge-termination voltage are adjusted using a set of registers.

5. The computer-implemented method of claim 4, wherein the set of registers is further used to record at least one of a cycle number, a cycle limit of the battery, the battery age, and the resting time.

6. The computer-implemented method of claim 1, wherein adjusting the charge-termination voltage of the battery based on the battery-usage parameters involves adjusting the charge-termination voltage based on a functional combination of multiple battery usage parameters.

7. The computer-implemented method of claim 1, wherein adjusting the charge-termination voltage of the battery based on the battery-usage parameters involves:
if a battery-usage parameter from the battery-usage parameters exceeds a pre-specified threshold, reducing the charge-termination voltage.

8. The computer-implemented method of claim 7, wherein the charge-termination voltage is reduced to improve at least one of the cycle life and the swell rate.

9. The computer-implemented method of claim 1, wherein adjusting the charge-termination voltage of the battery based on the battery-usage parameters involves:
temporarily increasing the charge-termination voltage based on the user input.

10. The computer-implemented method of claim 9, wherein the charge-termination voltage is increased to improve the runtime of the battery.

11. A computer-implemented method for managing use of a battery in a portable electronic device, comprising:
monitoring one or more battery-usage parameters of the battery during use of the battery with the portable electronic device, wherein the one or more battery-usage parameters comprise at least one of a swell rate, a temperature, a cell balance, a voltage, a current, a rate of change in battery capacity, an amount of time of banks in the battery can maintain a balanced state and user input; and
adjusting a discharge-termination voltage of the battery based on the battery-usage parameters to manage at least one of a cycle life of the battery, the swell rate, and a runtime of the battery.

12. The computer-implemented method of claim 11, wherein the one or more battery-usage parameters additionally comprise at least one of the following:
a battery age;
a resting time; and
usage data about how the battery has been cycled.

13. The computer-implemented method of claim 11, further comprising:
adjusting a charge-termination voltage of the battery based on the battery-usage parameters.

14. The computer-implemented method of claim 13, wherein the charge-termination voltage and the discharge-termination voltage are adjusted using a set of registers.

15. The computer-implemented method of claim 14, wherein the set of registers is further used to record at least one of a cycle number, a cycle limit of the battery, the battery age, and the resting time.

16. The computer-implemented method of claim 11, wherein adjusting the discharge-termination voltage of the battery based on the battery-usage parameters involves adjusting the discharge-termination voltage based on a functional combination of multiple battery usage parameters.

17. The computer-implemented method of claim 11, wherein adjusting the discharge-termination voltage of the battery based on the battery-usage parameters involves:
if a battery-usage parameter from the battery-usage parameters exceeds a pre-specified threshold, increasing the discharge-termination voltage.

18. The computer-implemented method of claim 11, wherein adjusting the discharge-termination voltage of the battery based on the battery-usage parameters involves:
temporarily decreasing the discharge-termination voltage based on the user input.

19. A system for managing use of a battery in a portable electronic device, comprising:
a monitoring mechanism configured to monitor one or more battery-usage parameters of the battery during use of the battery with the portable electronic device, wherein the one or more battery-usage parameters comprise at least one of a swell rate, a temperature, a cell balance, a voltage, a current, a rate of change in battery capacity, an amount of time of banks in the battery can maintain a balanced state and user input; and
a management apparatus configured to adjust a charge-termination voltage or a discharge-termination voltage of the battery based on the battery-usage parameters to manage at least one of a cycle life of the battery, the swell rate, and a runtime of the battery.

20. The system of claim 19, wherein the one or more battery-usage parameters additionally comprise at least one of the following:
a battery age;
a resting time; and
usage data about how the battery has been cycled.

21. The system of claim 19, further comprising:
a set of control registers configured to store the charge-termination voltage and the discharge-termination voltage.

22. The system of claim 21, wherein the control registers are further configured to store at least one of a cycle number and a cycle limit of the battery.

23. The system of claim 19, further comprising:
a non-resettable timer configured to track the battery age; and
a watchdog timer configured to track the resting time.

24. The system of claim 19, wherein adjusting the charge-termination voltage of the battery based on the battery-usage parameters involves adjusting the charge-termination voltage based on a functional combination of multiple battery usage parameters.

25. The system of claim 19, further comprising:
a lookup table comprising a set of elements, wherein each of the elements comprises:
a threshold for a battery-usage parameter from the battery-usage parameters;
a first value associated with the charge-termination voltage; and
a second value associated with the discharge-termination voltage.

26. The system of claim 25, wherein adjusting the charge-termination voltage or the discharge-termination voltage based on the battery-usage parameters involves:
if the battery-usage parameter exceeds the threshold, setting the charge-termination voltage to the first value and the discharge-termination voltage to the second value.

27. A computer-readable storage medium storing instructions that when executed by a computer cause the computer to perform a method for managing use of a battery in a portable electronic device, the method comprising:
monitoring one or more battery-usage parameters of the battery during use of the battery with the portable electronic device, wherein the one or more battery-usage parameters comprise at least one of a swell rate, a temperature, a cell balance, a voltage, a current, a rate of change in battery capacity, an amount of time of banks in the battery can maintain a balanced state and user input; and
adjusting a charge-termination voltage of the battery based on the battery-usage parameters to manage at least one of a cycle life of the battery, the swell rate, and a runtime of the battery.

28. The computer-readable storage medium of claim 27, wherein the one or more battery-usage parameters additionally comprise at least one of the following:
a battery age;
a resting time; and
usage data about how the battery has been cycled.

29. The computer-readable storage medium of claim 27, the method further comprising:
adjusting a discharge-termination voltage of the battery based on the battery-usage parameters.

30. The computer-readable storage medium of claim 29, wherein the charge-termination voltage and the discharge-termination voltage are adjusted using a set of registers.

31. The computer-readable storage medium of claim 27, wherein adjusting the charge-termination voltage of the battery based on the battery-usage parameters involves:
if a battery-usage parameter from the battery-usage parameters exceeds a pre-specified threshold, reducing the charge-termination voltage.

32. The computer-implemented method of claim 27, wherein adjusting the discharge-termination voltage of the battery based on the battery-usage parameters involves adjusting the discharge-termination voltage based on a functional combination of multiple battery usage parameters.

33. The computer-readable storage medium of claim 27, wherein adjusting the charge-termination voltage of the battery based on the battery-usage parameters involves:
temporarily increasing the charge-termination voltage based on the user input.
